(19) United States
(12) Patent Application Publication
(10) Pub. No.: US 2005/0083879 A1
(43) Pub. Date: Apr. 21, 2005

(54) Method and apparatus to improve quality of service in a wireless network

(75) Inventor: Greg A. Peek, North Plains, OR (US)

Correspondence Address: The Law Offices of John C. Scott, LLC;c/o PortfolioIP, P.O. Box 52050, Minneapolis, MN, 55402, US

(73) Assignee: Intel Corporation

(21) Appl. No.: 10/690,278

(22) Filed: Oct. 21, 2003

(51) Int. Cl. H04Q 7/00

(52) U.S. Cl. 370/329; 370/338

(57) ABSTRACT

Quality of service (QOS) may be improved within a wireless network by moving one or more wireless client devices from a present wireless channel to another channel in the network.

### FIELD OF THE INVENTION

The invention relates generally to wireless communications and, more particularly, to wireless networking.

### BRIEF DESCRIPTION OF THE DRAWINGS

FIG. 1 is a flowchart illustrating an example method for use in managing network operation within a wireless network in accordance with an embodiment of the present invention;

FIG. 2 is a block diagram illustrating an example wireless access point in accordance with an embodiment of the present invention; and

FIG. 3 is a diagram illustrating an example wireless network arrangement that may occur within a wireless network.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

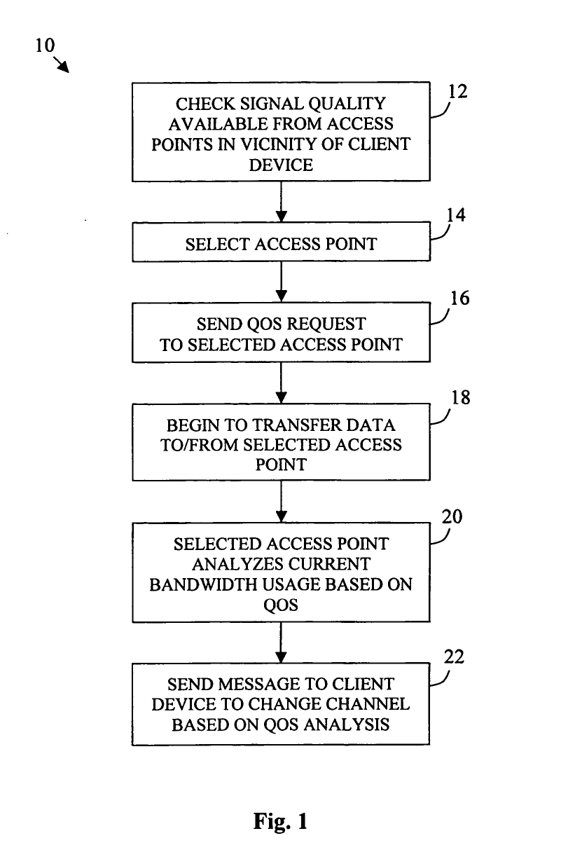

FIG. 1 is a flowchart illustrating an example method 10 for use in managing operation within a wireless network in accordance with an embodiment of the present invention. The wireless network may include at least one wireless client device and at least one wireless access point. A wireless client device may comprise any type of device that is capable of wirelessly accessing a network including, for example, a laptop, desktop, palmtop, or tablet computer having wireless networking functionality (e.g., a wireless network interface card (NIC), etc.), a personal digital assistant (PDA) with wireless functionality, a pager, a cellular telephone or similar wireless communicator, and/or others. A wireless client device that wishes to access the network may first check a signal quality (e.g., a signal strength, signal to noise ratio, etc.) that is available from access points within a vicinity of the device (block 12). The wireless client device may then select a wireless access point for use in accessing the network based on signal quality (block 14). Other methods for initially selecting a wireless access point may alternatively be used. The wireless client device may then optionally send a quality of service (QOS) request to the selected wireless access point requesting that a specific QOS be provided to the device (block 16). In at least one embodiment, the wireless client device does not send a QOS request. The wireless client device may then begin to transmit and receive data to/from the selected wireless access point (block 18). Other wireless client devices may also be communicating with and through the selected wireless access point at this time.

At some point, the selected wireless access point may analyze the current usage of the available bandwidth of the access point to determine whether the overall quality of service (QOS) being provided by the access point can be improved by moving at least one wireless client device being serviced by the access point to another available channel (block 20). For example, the wireless access point may have two wireless transceivers that can be used to provide access to the network and one of the transceivers may currently be serving multiple clients while the other is idle. A determination may then be made to move one or more of the clients from the busy transceiver to the idle transceiver to improve overall QOS. The wireless access point may then send a message to the wireless client device instructing it to move to another channel based on the QOS analysis (block 22). The wireless access point may utilize knowledge of the current usage of the various channels available in the network to make the QOS determination. Other factors may also be taken into account such as, for example, the capabilities of the wireless transceivers within the access point, the capabilities of the wireless transceivers within the client devices, the QOS requested by each client device, etc. In at least one embodiment of the invention, a QOS determination as described above is performed regularly during the operation of a wireless network (e.g., at periodic intervals, at preset times, etc.). The method 10 described above, and variants thereof, may be implemented within wireless networks following any wireless networking standard or combination of standards.

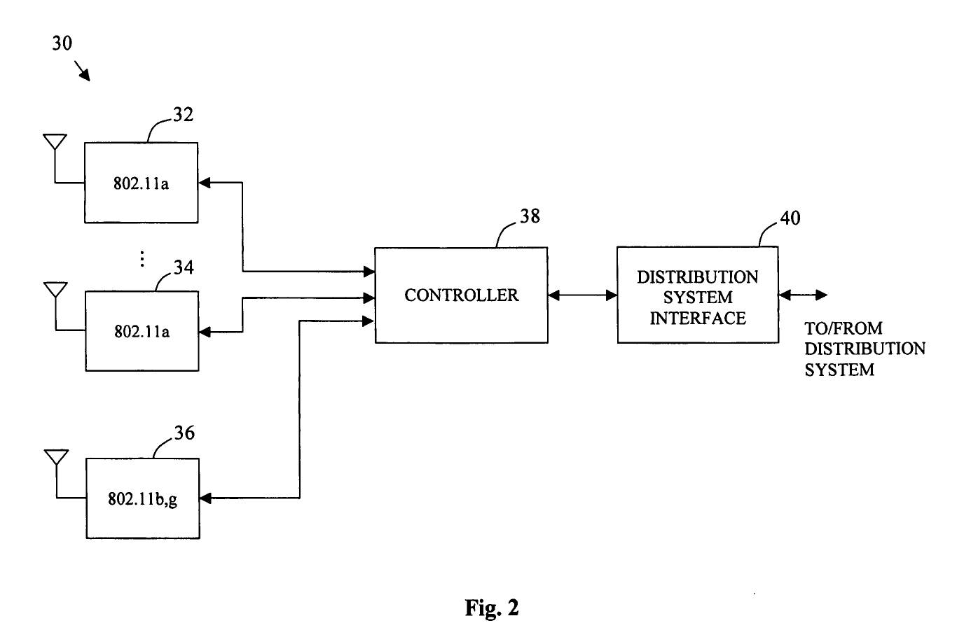

FIG. 2 is a block diagram illustrating an example wireless access point 30 in accordance with an embodiment of the present invention. As illustrated, the wireless access point 30 may include at least one of the following: one or more wireless networking transceivers 32, 34, 36; a controller 38; and a distribution system interface 40. The wireless networking transceivers 32, 34, 36 may include transceivers following the same or different wireless networking standards. For example, in the illustrated embodiment, two or more wireless networking transceivers 32, 34 within the access point 30 operate in accordance with the IEEE 802.11a wireless networking standard (IEEE Std 802.11a-1999) and one wireless networking transceiver 36 operates in accordance with the IEEE 802.11b,g standards (IEEE Std 802.11b-1999). Any other combination may alternatively be used. In at least one embodiment, a number of wireless networking transceivers are provided that each follow the same wireless networking standard (e.g., two IEEE 802.11a transceivers, etc.). In other embodiments, only a single wireless networking transceiver is present within a wireless access point. Each wireless networking transceiver 32, 34, 36 may include one or more dedicated antennas or antenna sharing may be implemented. Any type of antennas may be used including, for example, patches, dipoles, helixes, arrays, and/or others. In at least one embodiment, each available transceiver within an access point is coupled to at least one corresponding dipole antenna.

The controller 38 is operative for, among other things, managing the operation of the wireless networking transceivers 32, 34, 36. In at least one embodiment, the controller 38 may be implemented using one or more digital processing devices within the wireless access point 30 such as, for example, a general purpose microprocessor, a digital signal processor (DSP), a reduced instruction set computer (RISC), a complex instruction set computer (CISC), a field programmable gate array (FPGA), an application specific integrated circuit (ASIC), and/or others. Other implementations are also possible. The distribution system interface 40 is an interface between the access point 30 and a distribution system that may couple the access point 30 to other access points and/or other network entities.

From time to time, the controller 38 may perform an analysis of the current usage of the wireless access point 30 (e.g., an analysis of the current usage of different transceivers within the access point, etc.) to determine whether changes are possible that can result in an overall increase in QOS. For example, the controller 38 may determine that overall QOS would be improved if a particular client device that is currently using a first channel being supported by the first wireless networking transceiver 32 (an IEEE 802.11a transceiver) were moved to a second channel being supported by the third wireless networking transceiver 36 (an IEEE 802.11b,g transceiver). The controller 38 may then deliver a command to that client device to move to the second channel. The subject client device may then perform a handshake procedure to switch over to the second channel. Similarly, the controller 38 may determine that overall QOS would be improved if a client device currently using a channel supported by the first wireless networking transceiver 32 (an IEEE 802.11a transceiver) were moved to a channel being supported by the second wireless networking transceiver 34 (another IEEE 802.11a transceiver). The controller 38 would then send a message to the wireless client device to move to the new channel.

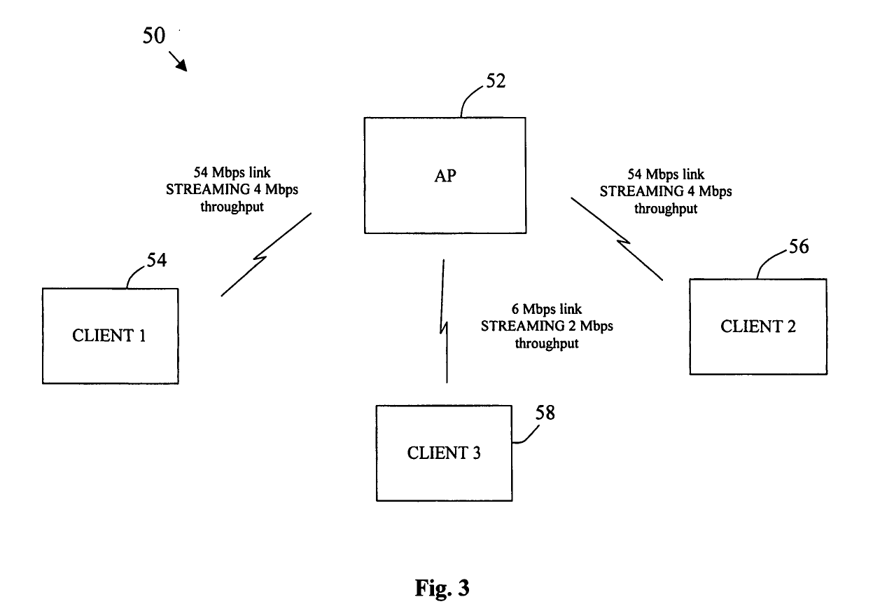

FIG. 3 is a diagram illustrating an example wireless network scenario 50 that may occur within a wireless network. As illustrated, a wireless access point 52 is providing access services for first, second, and third wireless client devices 54, 56, 58. In many wireless networking technologies, the data rate that is used within a particular network link is related to the signal quality within the link. Thus, when lower signal quality exists (e.g., lower signal to noise ratio), a lower speed modulation scheme may be used within the link. In the scenario illustrated in FIG. 3, the first, second, and third client devices 54, 56, 58 are sharing a wireless transceiver within the access point 52 (e.g., an IEEE 802.11a transceiver). The first and second client devices 54, 56 are each communicating with a relatively high signal quality and have thus requested the maximum data rate (i.e., 54 mega bits per second (Mbps) for an IEEE 802.11a transceiver). The third wireless client device 58, on the other hand, is communicating with the access point 52 with relatively low signal quality and has thus requested a lower data rate of 6 Mbps. In at least one embodiment, the requested data rate information will be available within the access point 52. In many wireless networking protocols, the actual data transfer rate deliverable is significantly less than the raw transfer rate selected. This is typically due to protocol overhead, such as collision avoidance, preambles, headers, cyclic redundancy checks (CRCs), inter-packet gaps, etc. In a wireless link following the IEEE 802.11a standard, for example, the actual data transfer rate is only about 50% of the raw transfer rate selected. Thus, a radio with a 54 Mbps link will consume 100% of the channel to transfer about 27 Mbps of actual data.

With reference to FIG. 3, the actual data rate being transferred by the first and second client devices 54, 56 is 4 Mbps. Therefore, the first and second client devices 54, 56 are each using about 4/27 of the available bandwidth of the IEEE 802.11a transceiver within the access point 52 (assuming the realized throughput is roughly half the raw throughput). The actual data rate being transferred by the third client device 58 is 2 Mbps. However, the third client device 58 has only requested a 6 Mbps data rate. Thus, the third client device 58 is utilizing ⅔ of the available bandwidth. Together, the first, second, and third wireless client devices 54, 56, 58 are using about 96% of the bandwidth available from the IEEE 802.11a transceiver within the access point 52. The third client device 58 is thus using a disproportionate amount of the available bandwidth because of the poor quality of the corresponding communication link.

Based on the above, a controller within the access point 52 of FIG. 3 may decide to move the third wireless client device 58 from the original IEEE 802.11a transceiver to another transceiver within the access point 52. The controller may decide, for example, to move the third wireless client device 58 to an IEEE 802.11b,g transceiver within the access point 52, while the first and second client devices 54, 56 remain with the IEEE 802.11a transceiver. Transceivers following the IEEE 802.11b,g standards are typically capable of achieving better range than IEEE 802.11a transceivers. Transceivers following the IEEE 802.11a standard, on the other hand, are typically capable of achieving slightly greater throughput than IEEE 802.11b,g transceivers. Therefore, an improvement in overall QOS may be achieved by moving client devices with low quality signals to IEEE 802.11b,g transceivers and client devices with higher quality signals to IEEE 802.11a transceivers. The third wireless client device 58 is likely to be able to connect at 5.5 Mbps using IEEE 802.11b and 6 Mbps using IEEE 802.11g. With the third wireless client device 58 moved, the original IEEE 802.11a transceiver will be reduced to about 29% capacity with only the first and second client devices 54, 56, thus allowing the transceiver to service other client devices in the system. In an alternative approach, it may be decided to move the third wireless client device 58 to another IEEE 802.11a transceiver or to a transceiver following some other wireless networking standard. The decision as to where to move a client device may depend upon, for example, the current usage of the other available transceivers within the access point 52, the capabilities of the other available transceivers within the access point 52 (e.g., range capability versus throughput capability, etc.), and/or other factors.

The access point 52 may change the channel being used by the third client device 58 in any of a variety of ways. In one approach, for example, the access point 52 sends a command to the third client device 58 instructing the device to move. This may be in accordance with, for example, the mechanisms made available by the IEEE 802.11h working group for use in changing the channel used by a client device when RADAR signals are present in the vicinity. Other techniques may alternatively be used.

In the embodiments described above, a decision may be made within an access point to move a client device to a different channel to improve the overall QOS being provided by the access point. It should be appreciated, however, that the decision making process does not have to be performed by the access point itself, but can instead be performed in another network location, such as a dedicated server or other structure within the network. This dedicated server may communicate with one or more access points within the network through, for example, a distribution system or other medium. In at least one embodiment of the invention, a decision may be made to “push” a particular client device from a current access point to another nearby access point on a different channel in order to improve QOS for the overall expanded network or for a portion thereof. For example, it may be determined that one access point is oversubscribed while another has excess capacity. In such a case, commands may be sent to one or more client devices being served by the first access point that instruct the devices to move to the second, underused access point. As before, such decisions may be made within an access point or at some other network location.

As used herein, the phrase “wireless access point” is intended to include, in addition to conventional wireless access points, structures that perform an access point function such as, for example, residential gateways having access point functionality, routers having access point functionality, wireless media centers, hotspots, and others.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

1. A method comprising:
determining whether quality of service (QOS) can be improved for a group of wireless client devices in a wireless network by moving at least one wireless client device in said group to another available channel; and
moving said at least one wireless client device to said another available channel when it is determined that QOS can be improved.

2. The method of claim 1, wherein:
determining includes estimating current usage of transceivers that are available to service wireless client devices within said group.

3. The method of claim 1, wherein:
determining includes analyzing data rates requested by wireless client devices within said group.

4. The method of claim 1, wherein:
moving includes sending a command to said at least one wireless client device instructing said at least one wireless client device to move to said another available channel.

5. The method of claim 1, wherein:
determining is performed within a wireless access point and said group of wireless client devices includes wireless client devices being serviced by said wireless access point.

6. The method of claim 5, wherein:
said another available channel includes another channel supported by said wireless access point.

7. The method of claim 1, wherein:
said another available channel includes at least one of: another channel supported by the same wireless access point that was previously servicing said at least one wireless client device and another channel supported by a different wireless access point than the one that was previously servicing said at least one wireless client device.

8. The method of claim 1, wherein:
moving said at least one wireless client device to said another available channel includes moving said at least one wireless client device to another frequency band.

9. The method of claim 1, wherein:
moving said at least one wireless client device to said another available channel includes moving said at least one wireless client device from a first transceiver within an access point to a second transceiver within the access point.

10. The method of claim 9, wherein:
said first transceiver follows a first wireless networking standard and said second transceiver follows a second wireless networking standard, wherein said second wireless networking standard is different from said first wireless networking standard.

11. The method of claim 9, wherein:
said first transceiver and said second transceiver follow a common wireless networking standard.

12. An apparatus comprising:
a first wireless transceiver to operate within a first channel;
a second wireless transceiver to operate within a second channel, wherein said second channel is different from said first channel; and
a controller to move a remote wireless client device from said first channel to said second channel when it is determined that such a move can improve an overall quality of service being provided by said apparatus.

13. The apparatus of claim 12, further comprising:
at least one other wireless transceiver to operate within at least one other channel, wherein said at least one other channel is different from said first and second channels.

14. The apparatus of claim 12, wherein:
said first wireless transceiver is configured in accordance with a first wireless networking standard and said second wireless transceiver is configured in accordance with a second wireless networking standard, wherein said first wireless networking standard is different from said second wireless networking standard.

15. The apparatus of claim 12, wherein:
said first wireless transceiver and said second wireless transceiver follow a common wireless networking standard.

16. The apparatus of claim 12, wherein:
said controller moves said remote wireless client device from said first channel to said second channel by sending a command to said remote wireless client device instructing said wireless client device to move to said second channel.

17. The apparatus of claim 12, wherein:
said apparatus includes a wireless access point.

18. An article comprising a storage medium having instructions stored thereon that, when executed by a computing platform, result in:
determining whether quality of service (QOS) can be improved for a group of wireless client devices in a wireless network by moving at least one wireless client device within said group to another available channel; and
moving said at least one wireless client device to said another available channel when it is determined that QOS can be improved.

19. The article of claim 18, wherein:
determining includes estimating current usage of transceivers that are available to service wireless client devices within said group.

20. The article of claim 18, wherein:
moving includes sending a command to said at least one wireless client device instructing said at least one wireless client device to move to said another available channel.

21. The article of claim 18, wherein:
said another available channel includes at least one of: another channel supported by the same wireless access point that was previously servicing said at least one wireless client device and another channel supported by a different wireless access point than the one that was previously servicing said at least one wireless client device.

22. A system comprising:
at least one first dipole antenna;
at least one second dipole antenna;
a first wireless transceiver, coupled to said at least one first dipole antenna, to operate within a first channel;
a second wireless transceiver, coupled to said at least one second dipole antenna, to operate within a second channel, wherein said second channel is different from said first channel; and
a controller to move a remote wireless client device from said first channel to said second channel when it is determined that such a move can improve an overall quality of service being provided by said system.

23. The system of claim 22, further comprising:
at least one other wireless transceiver to operate within at least one other channel, wherein said at least one other channel is different from said first and second channels.

24. The system of claim 22, wherein:
said first wireless transceiver is configured in accordance with a first wireless networking standard and said second wireless transceiver is configured in accordance with a second wireless networking standard, wherein said first wireless networking standard is different from said second wireless networking standard.

25. The system of claim 22, wherein:
said first wireless transceiver and said second wireless transceiver follow a common wireless networking standard.

26. The system of claim 22, wherein:
said controller moves said remote wireless client device from said first channel to said second channel by sending a command to said remote wireless client device instructing said remote wireless client device to move to said second channel.
